(19) United States
(12) Patent Application Publication
(10) Pub. No.: US 2026/0343044 A1
(43) Pub. Date: Oct. 29, 2026

(54) CUSTOMIZABLE USER INTERFACE FOR VIDEO BROADCAST AND STREAMING CONTENT

(71) Applicant: Clifford Dean Stephenson, JR., Altoona, IA (US)

(72) Inventor: Clifford Dean Stephenson, JR., Altoona, IA (US)

(21) Appl. No.: 19/660,923

(22) Filed: Apr. 28, 2026

Related U.S. Application Data
(60) Provisional application No. 63/797,074, filed on Apr. 29, 2025.

(51) Int. Cl. H04N 21/431; G06V 20/40

(52) U.S. Cl. CPC H04N 21/4316; G06V 20/42

(57) ABSTRACT

Examples of the present disclosure include an apparatus. The apparatus includes a streaming module that provides a stream of video content of an event via a user interface (UI). The apparatus also includes an overlay module that provides an overlay on the stream of video content. The apparatus includes an input module that receives, via the UI, a user input from a user. The user input includes a user preference relating to a parameter of the overlay. The user preference includes at least one of: a position of the overlay with respect to the video content, a font style of the overlay, a font size of the overlay, or a combination thereof. The apparatus also includes an update module that updates, during streaming of the video content and based at least in part on the user preference, the parameter of the overlay on the stream of video content.

### CROSS-REFERENCE TO RELATED APPLICATION

The application claims the benefit of U.S. Provisional Patent Application No. 63/797,074, entitled “CUSTOMIZABLE, INTEGRATED USER INTERFACE FOR VIDEO BROADCAST AND STREAMING” and filed on Apr. 29, 2026, which is incorporated herein by reference in its entirety.

### FIELD

The subject matter disclosed herein relates to user interfaces, and more particularly relates to a customizable user interface for video broadcast and streaming content.

### BACKGROUND

Live events, such as sporting competitions, concerts, conferences, and other real-time programming, can be distributed to viewers through digital broadcasting and streaming technologies. Such content can be delivered via over-the-top (OTT) platforms that transmit media content over internet protocol (IP) networks rather than through traditional broadcast, cable, or satellite television systems. Users may access OTT services using a variety of computing devices, including smart televisions, mobile devices, tablet computers, laptop computers, and set-top boxes. These devices typically present displays that enable users to browse available content, select live or scheduled events, and control playback of streaming media. The displays can present information relating to the event.

### SUMMARY

The subject matter of the present application has been developed in response to the present state of the art, and in particular, in response to the shortcomings associated with displays broadcasting and streaming. Accordingly, the subject matter of the present application has been developed to provide a customizable user interface for video broadcast and streaming content that overcomes at least some of the above-discussed shortcomings of prior art techniques.

The following is a non-exhaustive list of examples, which may or may not be claimed, of the subject matter, disclosed herein.

Disclosed herein is an apparatus. The apparatus includes a streaming module that provides a stream of video content of an event via a user interface (UI). The apparatus also includes an overlay module that provides an overlay on the stream of video content. The apparatus further includes an input module that receives, via the UI, a user input from a user, the user input including a user preference relating to a parameter of the overlay, the user preference including at least one of a position of the overlay with respect to the video content, a font style of the overlay, a font size of the overlay, or a combination thereof. The apparatus additionally includes an update module that updates, during streaming of the video content and based at least in part on the user preference, the parameter of the overlay on the stream of video content. At least a portion of said modules include one or more of hardware circuits, programmable hardware circuits and executable code, the executable code stored on one or more computer readable storage media. The preceding subject matter of this paragraph characterizes example 1 of the present disclosure.

The apparatus further includes an artificial intelligence (“AI”) module that trains an AI model on a corpus, the corpus including at least one of the user input, a sub-event corresponding to the user input, an additional input from an additional user, an additional sub-event corresponding to the additional input, or a combination thereof. The preceding subject matter of this paragraph characterizes example 2 of the present disclosure, wherein example 2 also includes the subject matter according to example 1, above.

The sub-event includes an event occurring within the event within a given time of the user input. The preceding subject matter of this paragraph characterizes example 3 of the present disclosure, wherein example 3 also includes the subject matter according to example 2, above.

The sub-event includes a first sub-event and the update module triggers, during streaming of at least one of the streamed event and a subsequent streamed event, an update to the overlay based at least in part on an occurrence of a second sub-event. The preceding subject matter of this paragraph characterizes example 4 of the present disclosure, wherein example 4 also includes the subject matter according to example 3, above.

The sub-event comprises a first sub-event. The apparatus further includes a computer vision module that inputs the video content into a computer vision model trained on a corpus of images of characters and an identification module that identifies, based at least in part on an output of the computer vision model and on an output of the AI model, a second sub-event and a character corresponding to the second sub-event. The overlay module provides, during streaming of at least one of the streamed event and a subsequent streamed event, an additional overlay based at least in part on the second sub-event and the identified character. The additional overlay comprises data relating to the second sub-event and to the identified character. The preceding subject matter of this paragraph characterizes example 5 of the present disclosure, wherein example 5 also includes the subject matter according to any of examples 3-4, above.

The AI module inputs the second sub-event into the AI model. The AI model is trained to identify a similarity between the first sub-event and the second sub-event. The update module determines an update to the overlay based at least in part on an output of the AI model and updates, during streaming of the at least one of the streamed event and the subsequent streamed event, the overlay based at least in part on the determined update. The preceding subject matter of this paragraph characterizes example 6 of the present disclosure, wherein example 6 also includes the subject matter according to any of examples 4-5, above.

The streamed event includes a sporting event and the sub-event includes at least one of: a goal, a game clock time, a shot clock time, a penalty, a foul, a shot on goal, a block, a replay, a hit, or a combination thereof. The preceding subject matter of this paragraph characterizes example 7 of the present disclosure, wherein example 7 also includes the subject matter according to example 6, above.

The streamed event includes an event of an event type. The apparatus further includes an artificial intelligence (“AI”) module that trains an AI model on a corpus, the corpus including video footage of the event type, and inputs the video content into the AI model. The apparatus also includes an identification module that identifies, in real-time, a sub-event based at least in part on an output of the AI model. The update module updates the parameter of the overlay based at least in part on the identified sub-event. The preceding subject matter of this paragraph characterizes example 8 of the present disclosure, wherein example 8 also includes the subject matter according to any of examples 1-7, above.

The stream of video content comprises a broadcast of an event. The apparatus further includes a data display module that provides, via the UI and an application programming interface (API) between the UI and an application, a display of data from the application corresponding to the video content. The input module receives, during the broadcast of the event and via the UI, a user input. The data display module updates, during the broadcast of the event and based at least in part on the user input, the display of data provided by the API. The preceding subject matter of this paragraph characterizes example 9 of the present disclosure, wherein example 9 also includes the subject matter according to any of examples 1-8, above.

The broadcasted event includes a sporting event and the displayed data includes at least one of: recorded player statistics, fantasy league data, or a combination thereof. The preceding subject matter of this paragraph characterizes example 10 of the present disclosure, wherein example 10 also includes the subject matter according to example 9, above.

The apparatus further includes an authentication module that authenticates the user, via the API, into an account associated with the application. The data display module provides the display of data corresponding to the video content in response to the authentication. The preceding subject matter of this paragraph characterizes example 11 of the present disclosure, wherein example 11 also includes the subject matter according to any of examples 9-10, above.

The user input includes a selection of an object within the video content and the identification module identifies a player profile corresponding to the object. The preceding subject matter of this paragraph characterizes example 12 of the present disclosure, wherein example 12 also includes the subject matter according to any of examples 9-11, above.

The data display module updates the display of data by including data corresponding to the identified player profile in the display of data. The preceding subject matter of this paragraph characterizes example 13 of the present disclosure, wherein example 13 also includes the subject matter according to example 12, above.

The apparatus further includes a natural language processing (“NLP”) module that trains an NLP model on a corpus of commentary corresponding to an event type of the event and tagged sub-events corresponding to portions of the commentary. The apparatus also includes a commentary module that provides a stream of commentary with the stream of video content and inputs the stream of commentary into the NLP model. The apparatus additionally includes an identification module that identifies a sub-event based at least in part on an output of the NLP model. The update module updates, during streaming of the event and based at least in part on the user preference and further based at least in part on the identified sub-event, the parameter of the overlay on the stream of video content. The preceding subject matter of this paragraph characterizes example 14 of the present disclosure, wherein example 14 also includes the subject matter according to any of examples 1-13, above.

The user input includes a user input of a plurality of user inputs. The apparatus further includes a weighting module that assigns a different weighting value of a plurality of weighting values to each user input of the plurality of user inputs. The update module updates the overlay based at least in part on the plurality of weighting values. The preceding subject matter of this paragraph characterizes example 15 of the present disclosure, wherein example 15 also includes the subject matter according to any of examples 1-14, above.

The plurality of user inputs includes at least one of the following received from a user device through which the UI is provided an audio input received from a microphone of the user device, a user location, and the user's browsing history. The preceding subject matter of this paragraph characterizes example 16 of the present disclosure, wherein example 16 also includes the subject matter according to example 15, above.

The apparatus further includes a feedback module that receives, in real time, feedback data indicative of a user satisfaction score. The update module iteratively compares the user satisfaction score to a threshold user satisfaction score and further updates the parameter of the overlay based at least in part on a difference between the user satisfaction score and the threshold user satisfaction score. The preceding subject matter of this paragraph characterizes example 17 of the present disclosure, wherein example 17 also includes the subject matter according to any of examples 1-16, above.

The apparatus further includes a UI module that provides the UI via a first user device of a plurality of user devices. The streaming module provides a synchronized stream of the video content to the plurality of user devices. The overlay module provides the overlay on the stream of video content to each user device of the plurality of user devices. The apparatus further includes a playback control module that controls the synchronized stream of the video content based at least in part on a playback control input received from the user. The update module selectively updates the parameter of the overlay on the stream of video content at the first user device from among the plurality of user devices. The preceding subject matter of this paragraph characterizes example 18 of the present disclosure, wherein example 18 also includes the subject matter according to any of examples 1-17, above.

Further disclosed herein is a method. The method includes providing a stream of video content of an event via a user interface (UI). The method also includes providing an overlay on the stream of video content. The method further includes receiving, via the UI, a user input from a user, the user input including a user preference relating to a parameter of the overlay, the user preference including at least one of a position of the overlay with respect to the video content, a font style of the overlay, a font size of the overlay, or a combination thereof. The method also includes updating, during streaming of the video content and based at least in part on the user preference, the parameter of the overlay on the stream of video content. The preceding subject matter of this paragraph characterizes example 19 of the present disclosure.

Additionally disclosed herein is a program product including a non-transitory computer readable storage medium that stores code executable by a processor, the executable code including code to perform providing a stream of video content of an event via a user interface (UI). The executable code also includes code to perform providing an overlay on the stream of video content. The executable code further includes receiving, via the UI, a user input from a user, the user input including a user preference relating to a parameter of the overlay, the user preference including at least one of a position of the overlay with respect to the video content, a font style of the overlay, a font size of the overlay, or a combination thereof. The executable code additionally includes updating, during streaming of the video content and based at least in part on the user preference, the parameter of the overlay on the stream of video content. The preceding subject matter of this paragraph characterizes example 20 of the present disclosure.

### BRIEF DESCRIPTION OF THE DRAWINGS

A more particular description of the examples briefly described above will be rendered by reference to specific examples that are illustrated in the appended drawings. Understanding that these drawings depict only some examples and are not therefore to be considered to be limiting of scope, the examples will be described and explained with additional specificity and detail through the use of the accompanying drawings, in which:

FIG. 1 is a schematic block diagram illustrating a system for user interface (“UI”) customization, according to one or more examples;

FIG. 2 is a schematic block diagram illustrating an apparatus for UI customization, according to one or more examples; and

FIG. 3 is a schematic block diagram illustrating an apparatus for UI customization with artificial intelligence (“AI”) capabilities, according to one or more examples;

FIG. 4A illustrates a custom UI apparatus having a UI for viewing a streamed event, according to one or more examples;

FIG. 4B illustrates a custom UI apparatus having a UI with an adaptive overlay, according to one or more examples;

FIG. 4C illustrates a custom UI apparatus having a UI presenting a user prompt for customizing an overlay, according to one or more examples;

FIG. 4D illustrates a custom UI apparatus having a UI with a custom overlay, according to one or more examples;

FIG. 5A illustrates a custom UI apparatus having a UI and object recognition functions, according to one or more examples;

FIG. 5B illustrates a custom UI apparatus with a customized, object-based overlay, according to one or more examples;

FIG. 5C illustrates a custom UI apparatus with an integrated betting functionality; and

FIG. 6 is a schematic flowchart diagram illustrating one example of a method for UI customization.

### DETAILED DESCRIPTION

Internet-connected devices enable viewing of live events, such as sports events, via streaming platforms. The streaming platforms control the displays (e.g., non-customizable or fixed overlays (e.g., score bugs)) that viewers see while streaming video content. Examples of the present disclosure include methods, systems, and apparatuses for user interface (UI) customization that help to create a dynamic, personalized, and enhanced viewing experience. Examples of the present disclosure automatically help users access real-time metrics that are of interest to them, customize viewing preferences, manage notifications, integrate with other relevant content and services, engage interactive features, and/or seamlessly navigate between multiple devices.

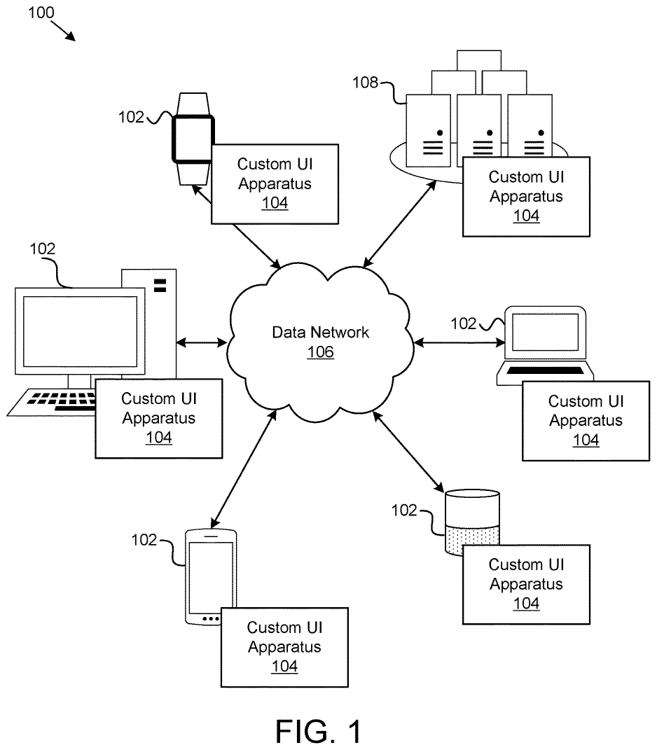

FIG. 1 is a schematic block diagram illustrating one example of a system 100 for UI customization. In one example, the system 100 includes one or more information handling devices 102, one or more custom UI apparatuses 104, one or more data networks 106, and one or more servers 108. In certain examples, even though a specific number of information handling devices 102, custom UI apparatuses 104, data networks 106, and servers 108 are depicted in FIG. 1, one of skill in the art will recognize, in light of this disclosure, that any number of information handling devices 102, custom UI apparatuses 104, data networks 106, and servers 108 may be included in the system 100.

In one example, the information handling devices 102 may include one or more of a desktop computer, a laptop computer, a tablet computer, a smart phone, a smart speaker (e.g., Amazon Echo®, Google Home®, Apple HomePod®), a security system, a set-top box, a gaming console, a smart TV, a smart watch, a fitness band or other wearable activity tracking device, an optical head-mounted display (e.g., a virtual reality headset, smart glasses, or the like), a High-Definition Multimedia Interface (“HDMI”) or other electronic display dongle, a personal digital assistant, a digital camera, a video camera, or another computing device comprising a processor (e.g., a central processing unit (“CPU”), a processor core, a field programmable gate array (“FPGA”) or other programmable logic, an application specific integrated circuit (“ASIC”), a controller, a microcontroller, and/or another semiconductor integrated circuit device), a volatile memory, and/or a non-volatile storage medium.

In certain examples, the information handling devices 102 are communicatively coupled to one or more other information handling devices 102 and/or to one or more servers 108 over a data network 106, described below. The information handling devices 102, in a further example, may include processors, processor cores, and/or the like that are configured to execute various programs, program code, applications, instructions, functions, and/or the like. The information handling devices 102 may include various sensors for sensing, collecting, monitoring, or the like environmental data. The sensors may include location sensors (e.g., global positioning system (“GPS”) sensors), proximity sensors, wireless signal sensors (e.g., sensors configured to sense wireless signals emitted from other devices such as Bluetooth® signals, Wi-Fi signals, near field communication (“NFC”) signals, and/or the like), accelerometers, gyroscopes, light sensors, sound sensors, biometric sensors (e.g., blood pressure sensors, heart-rate monitors, fingerprint sensors, oxygen sensors, and/or the like), and/or the like. The information handling device 102 may also include integrated displays for presenting UIs, visual information, and/or video content to a user. The displays can present graphical user interfaces, application screens, video feeds, textual data, sensor readings, and/or interactive elements. These displays may include various technologies such as Liquid Crystal Displays (LCDs), Light-Emitting Diodes (LEDs), Organic Light-Emitting Diodes (OLEDs), and/or touch-sensitive screens.

In one example, the custom UI apparatus 104 is configured to provide a stream of video content via a user interface. As used herein, the term “user interface” includes any hardware component, software component, or combination thereof that enables interaction between the user and the information handling device 102 and/or a software application accessible through the information handling device 102, including but not limited to graphical user interfaces (GUIs), text-based interfaces, touch-sensitive displays, voice-based interfaces, gesture-based interfaces, haptic feedback mechanisms, physical input devices such as keyboards, mice, buttons, sliders, remote controls, and switches, as well as output components such as displays, speakers, indicators, or other elements configured to present information to the user. The term “user interface” can include combinations of an interface component that receives preference input from the user and a display component that does not receive preference input from the user but instead displays overlays onto video content based on the preference input received via the interface component. The term “user interface” can include combinations of components engaged by the user to control any aspect of a stream of video content (e.g., overlays, settings, selection of content, etc.).

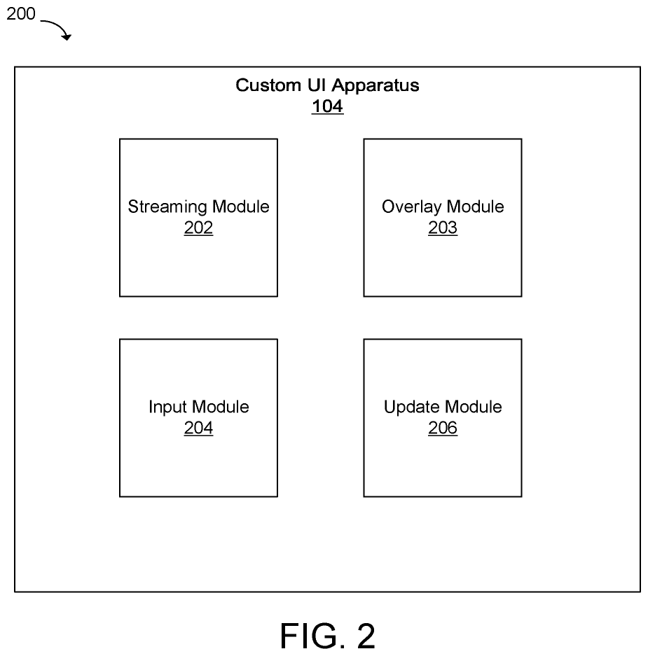

In some examples, the custom UI apparatus 104 is configured to receive a user preference and update an overlay of the stream of video content during streaming of an event and based at least in part on the user preference. An overlay can be part of the UI. In some examples, the UI is configured to receive input from the user at the overlay portion of the UI. An overlay can also be a component of a display of streamed content that is manipulatable by the user via a separate interface (e.g., a separate, settings interface for the streaming application). In some examples, the custom UI apparatus 104 is configured to display a video broadcast of an event via a user interface (“UI”) and display data from other applications via the user interface that is relevant to the video broadcast through, for example, an application programming interface (“API”). The custom UI apparatus 104, including its various sub-modules, may be located on one or more information handling devices 102 in the system 100, one or more servers 108, one or more network devices, and/or the like. The custom UI apparatus 104 is described in more detail below with reference to FIGS. 2, 3, 4A-D, and 5A-C.

In one example, the custom UI apparatus 104 improves upon conventional streaming systems by updating a UI through which it presents streamed video content based on learned preferences of the user that are tied to particular occurrences within the event being streamed, as described in more detail below. In some examples, the custom UI apparatus 104 improves on conventional UI customization systems by integrating a display of relevant data from other applications into a UI based at least in part on user preferences.

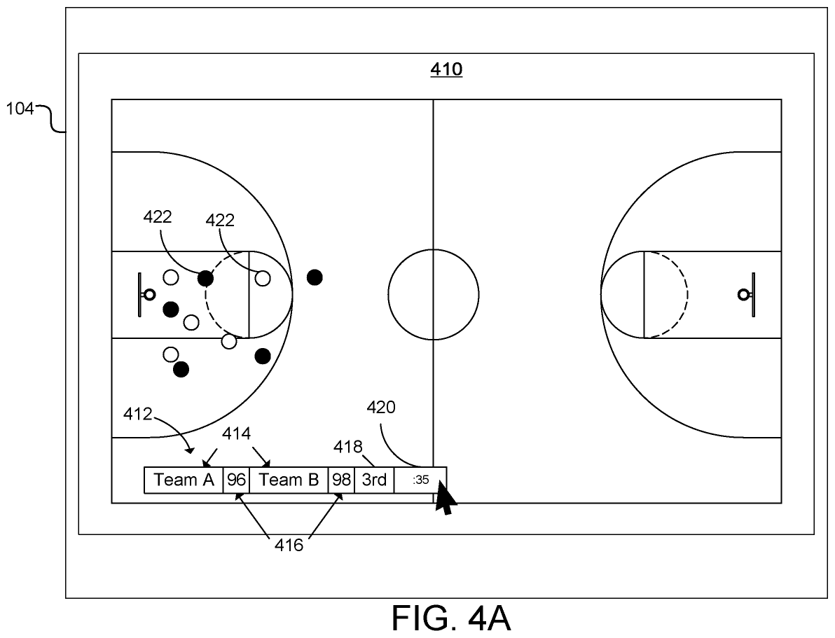

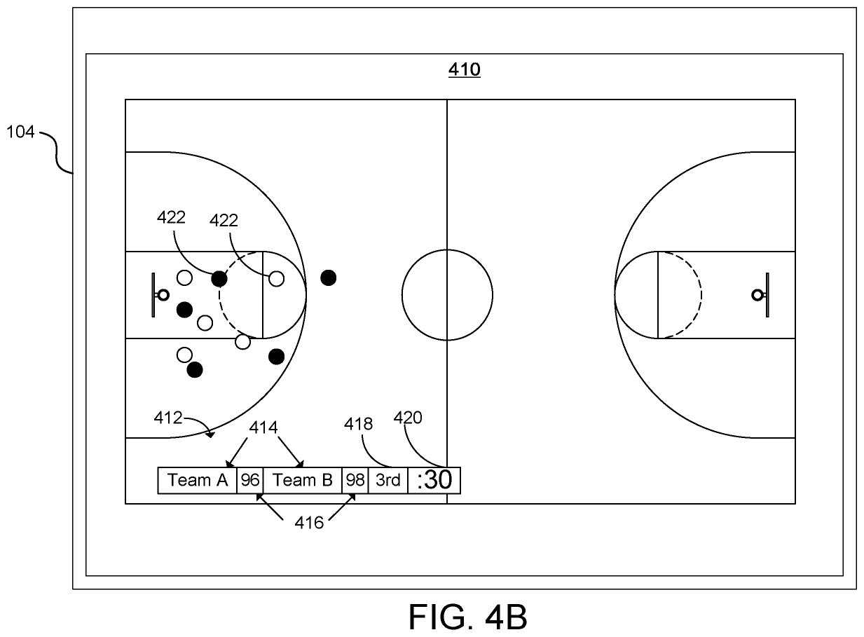

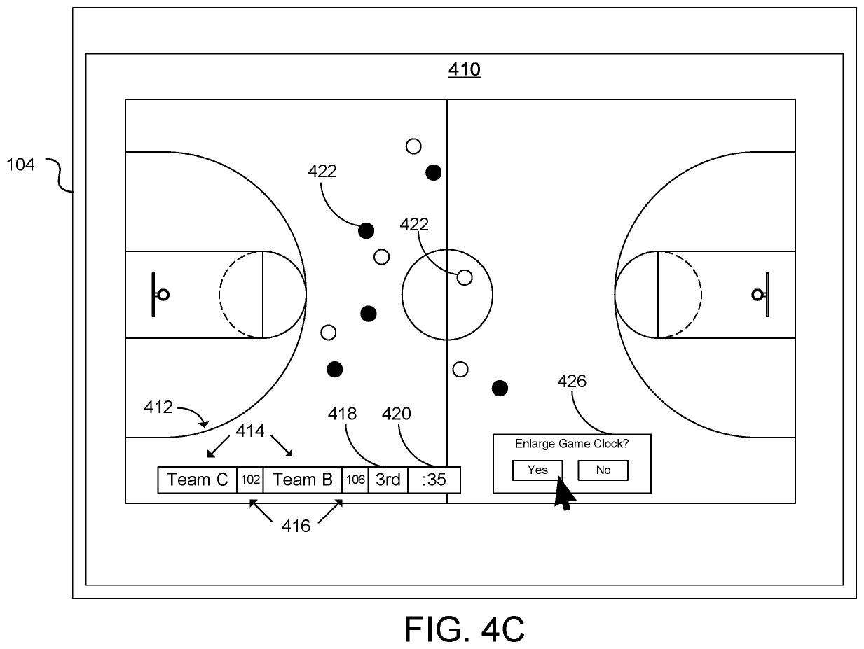

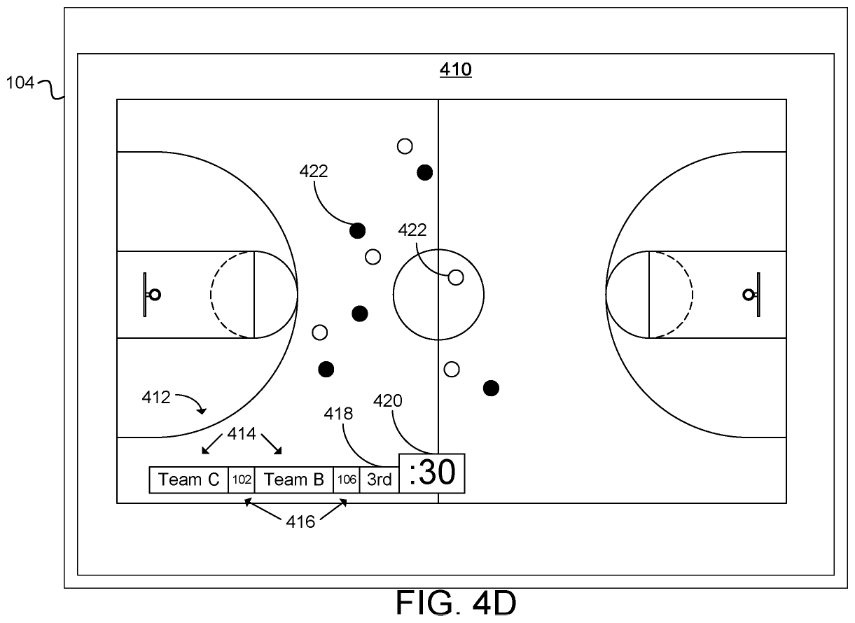

Referring to FIGS. 1 and 4A-D, in some examples, the custom UI apparatus 104 seamlessly integrates real-time stats, fantasy insights, and betting odds into a single-screen UI 410. In some examples, the custom UI apparatus 104 presents a hybrid solution that combines user-defined customization with AI-powered automation—helping to enhance engagement, reduce second-screen distractions, and unlock new revenue through targeted advertising and premium subscriptions.

In various examples, the custom UI apparatus 104 may be embodied as a hardware appliance that can be installed or deployed on an information handling device 102, on a server 108, or elsewhere on the data network 106. In certain examples, the custom UI apparatus 104 may include a hardware device such as a secure hardware dongle or other hardware appliance device (e.g., a set-top box, a network appliance, or the like) that attaches to a device such as a laptop computer, a server 108, a tablet computer, a smart phone, a security system, or the like, either by a wired connection (e.g., a universal serial bus (“USB”) connection) or a wireless connection (e.g., Bluetooth®, Wi-Fi, near-field communication (“NFC”), or the like); that attaches to an electronic display device (e.g., a television or monitor using an HDMI port, a DisplayPort port, a Mini DisplayPort port, VGA port, DVI port, or the like); and/or the like. A hardware appliance of the custom UI apparatus 104 may include a power interface, a wired and/or wireless network interface, a graphical interface that attaches to a display, and/or a semiconductor integrated circuit device as described below, configured to perform the functions described herein with regard to the custom UI apparatus 104.

The apparatus 104, in such an example, may include a semiconductor integrated circuit device (e.g., one or more chips, die, or other discrete logic hardware), or the like, such as a field-programmable gate array (“FPGA”) or other programmable logic, firmware for an FPGA or other programmable logic, microcode for execution on a microcontroller, an application-specific integrated circuit (“ASIC”), a processor, a processor core, or the like. In one example, the custom UI apparatus 104 may be mounted on a printed circuit board with one or more electrical lines or connections (e.g., to volatile memory, a non-volatile storage medium, a network interface, a peripheral device, a graphical/display interface, or the like). The hardware appliance may include one or more pins, pads, or other electrical connections configured to send and receive data (e.g., in communication with one or more electrical lines of a printed circuit board or the like), and one or more hardware circuits and/or other electrical circuits configured to perform various functions of the apparatus 104.

The semiconductor integrated circuit device or other hardware appliance of the apparatus 104, in certain examples, includes and/or is communicatively coupled to one or more volatile memory media, which may include but is not limited to random access memory (“RAM”), dynamic RAM (“DRAM”), cache, or the like. In one example, the semiconductor integrated circuit device or other hardware appliance of the custom UI apparatus 104 includes and/or is communicatively coupled to one or more non-volatile memory media, which may include but is not limited to: NAND flash memory, NOR flash memory, nano random access memory (nano RAM or NRAM), nanocrystal wire-based memory, silicon-oxide based sub-10 nanometer process memory, graphene memory, Silicon-Oxide-Nitride-Oxide-Silicon (“SONOS”), resistive RAM (“RRAM”), programmable metallization cell (“PMC”), conductive-bridging RAM (“CBRAM”), magneto-resistive RAM (“MRAM”), dynamic RAM (“DRAM”), phase change RAM (“PRAM” or “PCM”), magnetic storage media (e.g., hard disk, tape), optical storage media, or the like.

The data network 106, in one example, includes a digital communication network that transmits digital communications. The data network 106 may include a wireless network, such as a wireless cellular network, a local wireless network, such as a Wi-Fi network, a Bluetooth® network, a near-field communication (“NFC”) network, an ad hoc network, and/or the like. The data network 106 may include a wide area network (“WAN”), a storage area network (“SAN”), a local area network (“LAN”), an optical fiber network, the internet, or other digital communication network. The data network 106 may include two or more networks. The data network 106 may include one or more servers, routers, switches, and/or other networking equipment. The data network 106 may also include one or more computer readable storage media, such as a hard disk drive, an optical drive, non-volatile memory, RAM, or the like.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a Bluetooth® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (ASTM®), the DASH7™ Alliance, and EPCGlobal™.

Alternatively, the wireless connection may employ a ZigBee® connection based on the IEEE 802 standard. In one example, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA”®). Alternatively, the wireless connection may be a cellular telephone network communication. All standards and/or connection types include the latest version and revision of the standard and/or connection type as of the filing date of this application.

The one or more servers 108, in one example, may be embodied as blade servers, mainframe servers, tower servers, rack servers, and/or the like. The one or more servers 108 may be configured as mail servers, web servers, application servers, FTP servers, media servers, data servers, web servers, file servers, virtual servers, and/or the like. The one or more servers 108 may be communicatively coupled (e.g., networked) over a data network 106 to one or more information handling devices 102. For instance, a server 108 may be an intermediary between information handling devices 102 to facilitate sending and receiving electronic messages between the information handling devices 102.

FIG. 2 is a schematic block diagram illustrating one example of an apparatus 200. In one example, the apparatus 200 includes an example of the custom UI apparatus 104. The custom UI apparatus 104, in some examples, includes one or more of a streaming module 202, an overlay module 203, an input module 204, and an update module 206.

The streaming module 202 provides a stream of video content of an event over a streaming system and presents the stream of video content to the user through a user interface (“UI”). In some examples, the stream of video content includes a video recording and/or a broadcasted event. In some examples, the stream of video content includes a broadcast provided by another party, such as a television network, broadcast network, and/or sports network. In some examples, the streaming module 202 is configured to provide the UI via a streaming application. As used herein, “a streaming application” includes streamlining services, Over-the-Top (OTT) platforms, and/or any other applications or services which deliver media over the internet.

The streaming module 202, in some examples, provides a UI. In some examples, the UI is a graphical UI (“GUI”). In some examples, the UI is a UI of a streaming application. For example, the UI can be a UI of an OTT platform. In some examples, the UI includes input elements such as buttons, icons, menus, and/or visual indicators that allow a user to interact with the streaming application. In some examples, the UI is a GUI that features controls such as play, pause, and/or volume controls represented by icons.

In some examples, the overlay module 203 provides an overlay (i.e., graphical overlay) on the stream of video content. In some examples, the overlay module 203 is configured to provide an overlay on the stream of video content. In some examples, the overlay is part of the broadcast and is provided by the broadcast provider. As used herein, the term “overlay” refers to any generated graphic included on the stream of video content that is not a tangible object captured in the recording of the video content. In some examples, the overlay module 203 generates the overlay and overlays it onto the video content. In some examples, the overlay is configured to provide information about the event being broadcasted. In some examples, the overlay includes at least one of: a score bug, a ticker, a graphic, an information bar, a data overlay, a banner, a character generator, a scoreboard, or a combination thereof.

In some examples, the overlay module 203 provides the overlay at the streaming layer. For example, the overlay can be a graphic overlaid onto a broadcasted video feed and is not included in the broadcast. By providing the overlay at the streaming layer, the overlay module 203 can provide the overlay, and other modules can update the overlay, during delivery to a user device 102, independent of underlying broadcast infrastructure. Accordingly, the overlay module 203 can provide the overlay using application-level logic, streaming protocols, and client-side or server-side processing resources without modifying broadcast transmission.

In some examples, the overlay module 203 provides the overlay such that the overlay is persistently available and/or visible on the display of the UI throughout streaming of the event. For example, the overlay module 203 can keep the overlay present on the display, even if a playback menu is no longer visible on the display. In some examples, the overlay module 203 provides the overlay persistently, such that the overlay remains visible even after a given period of time has passed since input from or interaction with the user.

The input module 204, in some examples, receives, via the UI, a user input. In some examples, the input module 204 receives the input via any component of the user device 102, such as a microphone, location-sharing setting, browser history, biometric sensors, or a combination thereof. In some examples, the user input includes a user preference relating to the content displayed on the UI. For example, the user input can include a team or event type preference. In some examples, the user input includes a user preference relating to a parameter of the overlay. The user preference may include at least one of: a position of the overlay with respect to the video content, a font style on the overlay, a font size of the overlay, a visibility state, or a combination thereof. In some examples, the user input indicates a user preference. In some examples, the user preference includes a position of the overlay with respect to the video content. For example, the user may wish to drag the overlay to a different location on the UI display. In some examples, the user preference includes a font style of text within the overlay. In some examples, the custom UI apparatus 104 or the overlay module 203 is configured to present a drop-down menu of font style options and receive a selection from the user. In some examples, the drop-down menu drops down from the overlay in response to the user selecting the overlay. In some examples, the user preference includes a size of the overlay. In some examples, the user preference includes a font size of text within the overlay.

In some examples, the visibility state includes whether the overlay is shown or hidden, minimized or expanded, collapsed, or fully visible. According to one or more examples, the visibility state can include a preference that the overlay be conditionally displayed based on a context of the event or a sub-event occurring within the event. For example, the user preference can include automatically showing a player stats overlay during a free throw, but minimizing that overlay during live play. In some examples, the user preference includes hiding a betting odds overlay by default, but surfacing that overlay during specific sub-events and/or based on user behavior. According to one or more examples, the user preference includes expanding a data panel overlay during particular sub-events and reducing it once the sub-event has concluded.

In some examples, the overlay parameter includes a length of time during which the overlay remains in a particular visibility state. For example, the overlay parameter can include a time period during which the overlay is visible before disappearing from the display. In some examples, the overlay parameter includes a transition type that defines how the overlay transitions between various visibility states. For example, the transition can include fading, gradual minimization, gradual expansion, instant minimization, instant expansion, instant removal, sliding in or out from a display edge, dissolving, blurring, sharpening, snapping into position, zooming in or out, cross-fading between two different overlay types, animating along a predefined motion path, flipping or rotating, or performing an animation effect with the transition.

In some examples, the input module 204 is configured to save settings and preferences to a user profile that is accessible to the user via more than one information handling device 102. In some examples, the settings determined based on viewing and interaction patterns on one information handling device 102 (e.g., a mobile device) are adapted for viewing on another information handling device 102 (e.g., a TV). In some examples, the custom UI apparatus 104 or the overlay module 203 determines overlay size preferences for the user based at least in part on the user's interaction and viewing patterns on a mobile device and saves these preferences to the user profile. In some examples, the custom UI apparatus 104 detects that a user is viewing an event through a different information handling device 102, such as a TV, and modifies the user preferences for the overlay size based at least in part on a difference between sizes of the viewing screens for the information handling devices 102.

In some examples, the user input includes a selection of a mode from a plurality of modes. For example, each mode of the plurality of modes includes a plurality of settings relating to the appearance of an overlay or display of data on the UI. In some examples, the modes include a “minimalist” mode that minimizes the overlays and/or keeps the font size to a minimum, a “fantasy” mode that includes fantasy data in the displayed data, and/or an “advanced stats” mode that includes player statistics in data display and/or on the overlay.

The update module 206 updates, during streaming of the video content and based at least in part on the user preference, the parameter of the overlay on the stream of video content. In some examples, the update module 206 updates the parameter of the overlay at the application layer rather than at the broadcast layer. The custom update module 206 is configured to adjust the size, style, position, and/or content of elements shown on the UI, such as an overlay, based on user preferences, real-time game conditions, and/or viewing context—without relying solely on manual intervention. In some examples, the update module 206 is configured to update the overlay in real-time in response to a user input and/or an occurrence corresponding with a learned user preference.

In some examples, the update module 206 is configured to learn user preferences and predict updates to the overlay. In some examples, the input module 204 is configured to store selections and preferences of the user to a user profile. In some examples, the update module 206 is configured to apply user preferences to subsequent viewing of video content. For example, if the user frequently resizes or repositions an element (e.g., the overlay), the custom UI apparatus 104 or the update module 206 stores this preference and applies the size and/or position settings to the overlay for future events.

In some examples, the update module 206 is configured to determine a deactivation of a particular feature based on use activity. For example, if the user stops interacting with a certain feature of the UI over time, update module 206 can prompt, via the UI: “You haven't used Betting Odds in the last three games—would you like to hide it by default?” In some examples, the UI includes options selectable for the user to accept, decline, or defer the decision. In some examples, the update module 206 presents a notification via the UI, and the notification asks for a confirmation of the AI-determined adjustment (e.g., “Would you like to automatically show Fantasy Stats during free throws?” or “Would you like to expand player statistics during the final minutes?”). In some examples, the user accepts certain suggestions (e.g., automatically showing fantasy stats) but declines others (e.g., betting odds minimization). In some examples, the custom UI apparatus 104 respects this choice and updates the personalization model accordingly.

In some examples, the update module 206 presents a notification to the user via the UI asking for confirmation of updates determined by the update module 206. In some examples, a positive acknowledgement from the user triggers an update to the overlay, while a negative acknowledgement does not trigger an update to the overlay. In some examples, the update module 206 makes changes, such as AI-powered changes, to the overlay autonomously, but is also configured to override AI-powered changes based on user input (e.g., using manual controls, voice commands, or gesture-based interactions) if desired.

In some examples, the update module 206 is configured to determine that an adjustment obstructs critical game information (e.g., covering the score or game clock with another element of the overlay and/or an additional overlay), the custom UI apparatus 104 immediately reverts to a safe default layout for the UI. In some examples, the update module 206 is configured to determine that an adjustment to the UI negatively impacts visibility (e.g., covering key elements of the overlay) and automatically refer to default display settings. In some examples, the user input includes overriding of a change powered by the AI model via manual controls (e.g., remote, touchscreen, keyboard), voice commands, or input received through an AI settings dashboard. The AI settings dashboard is accessible via the UI, logs past AI-powered updates, and allows for granular adjustment of user settings.

In some examples, the input module 204 stores user preferences to a user account profile, helping to maintain a consistent experience for the user across different user devices 102 accessed by the user. In some examples, the update module 206 is configured to update one or more overlays and/or displays that remain persistently visible across multiple broadcasts and/or devices, such that if a viewer switches between live or archived events within the same streaming platform, the UI remains active and dynamically updates its content to reflect the new event context. As such, examples of the present disclosure provide continuity that helps to enhance user engagement by preserving familiarity and reducing friction during mid-session transitions. In some examples, the custom UI apparatus 104 maintains user-defined preferences and/or real-time AI optimizations without requiring reinitialization.

In some examples, the overlay parameter includes a type of data displayed and/or not displayed in the overlay. For example, the update module 206 can determine updates to an overlay that presents contextual information (e.g., statistics, information about actors in an event, etc.). In some examples, the update module 206 is configured to remove certain statistics from one or more overlays based on a user preference. For example, the input module 204 can provide one or more toggling functions on the UI that allow the user to manually hide and/or display certain overlays. In some examples, the update module 206 is configured to update the overlay based at least in part on input received via this toggle. In some examples, the update module 206 is configured to provide an option on the UI selectable for the user to enable and/or disable AI-powered updates.

In some examples, the update module 206 determines updates to the overlay parameter based purely on inferred behavior or preferences. For example, the update module can determine updates to the overlay parameter based at least in part on a profile of the user and on preferences of users with similar profiles. In some examples, the user profile includes attributes, such as demographic attributes. For example, the update module 206 determines that users of a gender, age group, and/or viewing history that matches that of the user have a particular overlay preference. The update module 206 then determines the update based on inferences made about the user, which are informed by preferences of other users. In some examples, the update module 206 makes these inferences based on the output from AI model, which is trained on preferences of other users with similar attributes. In some examples, the update module 206 updates the overlay in real-time without selection or activation by the user.

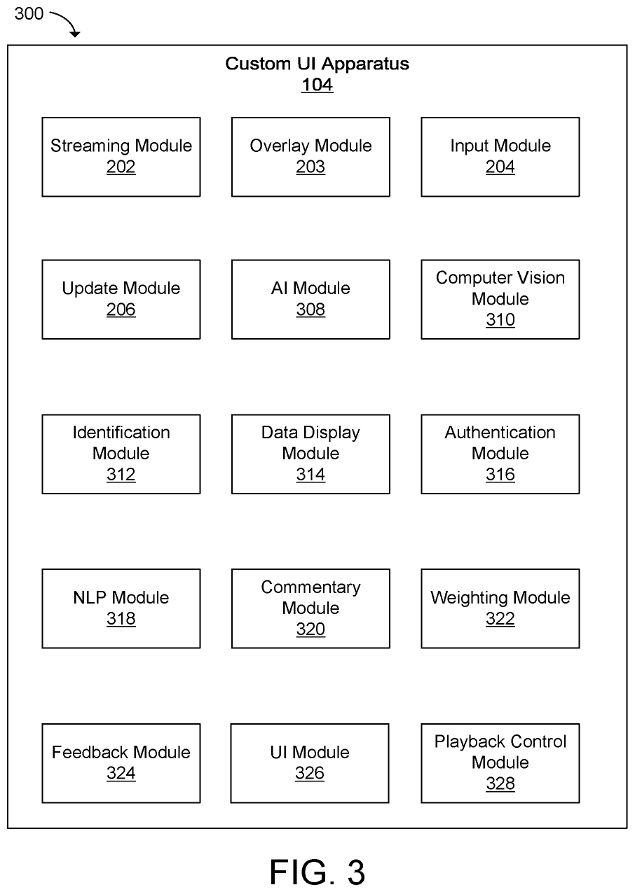

Referring to FIG. 3, examples of the present disclosure include an apparatus 300. Referring to FIGS. 1-3, the apparatus 300 is an example of the custom UI apparatus 104 and of the apparatus 200. In some examples, the apparatus 300 includes one or more of the streamlining module 202, the overlay 203, the input module 204, and the update module 206 described in connection with FIG. 2. The apparatus 300 includes one or more of an artificial intelligence (“AI”) module 308, a computer vision module 310, an identification module 312, a data display module 314, an authentication module 316, a natural language processing (“NLP”) module 318, a commentary module 320, a weighting module 322, a feedback module 324, a user interface (“UI”) module 326, and/or a playback control module 328.

The AI module 308 trains an AI model on a corpus. The corpus includes at least one of: the user input, a sub-event corresponding to the user input, an additional input from an additional user, an additional sub-event corresponding to the additional input, or a combination thereof. In some examples, the AI model continuously learns from interactions, historical behaviors, and game contexts to help optimize visibility, relevance, and/or engagement. In some examples, the update module 206 is configured to, as the event (e.g., a game) progresses, fine-tune adjustments to the UI based on additional user actions using an AI model.

In some examples, the AI model determines improvements driven by reinforcement learning, user feedback loops, and/or pre-trained engagement models. In some examples, the update module 206 uses the AI model to personalize the user interface from first use, using inferred behaviors, default settings, and/or game context for initial customization. In some examples, the update module 206 is configured to provide an AI settings dashboard via the UI to allow the user to review past AI-powered optimizations and adjust preferences in real time.

In some examples, the AI model is configured to link the user input to a sub-event. In some examples, the AI model is configured to link the user input to the sub-event by comparing time stamps of the occurrence of the sub-event and the received user input. In some examples, the update module 206 is configured to trigger, during streaming of the event and/or streaming of a similar, subsequent event, an update to the overlay based at least in part on an occurrence of a second sub-event and/or a similarity between the first sub-event and the second sub-event. The AI model is trained to identify a similarity between the first sub-event and the second sub-event. In some examples, the sub-event is an event occurring within the streamed event within a given time of the user input. In some examples, the streamed event is a sporting event, and the sub-event includes at least one of: a goal, a game clock time, a shot clock time, a penalty, a foul, a shot on goal, a block, a replay, a timeout, a hit, or a combination thereof.

In some examples, the update module 206 predicts a desired user update to the UI, such as updates to the overlay. In some examples, the update module 206 makes updates to the overlay based at least in part on predictions made by the AI module 308 based at least in part on learned user behaviors. In some examples, the update module 206 determines an update to the overlay based at least in part on an output of the AI model. The update module 206 also updates the overlay, during streaming of the event, based at least in part on the determined update. For example, based on user preference, the update module 206 determines to update an overlay to provide player stats free-throw. In some examples, the update module 206 determines this update by identifying a first sub-event, which occurs when the input module 204 receives the preference from the user, as a free throw. The AI module 308 identifies a second, subsequent sub-event that appears to be similar to or associated with the first sub-event. According to some examples, the update module 206 determines to make a similar update to the overlay based on an inference that the second sub-event is also a free-throw.

In some examples, the corpus on which the AI module 308 trains the AI model includes video footage, which can include historical game footage and/or player statistics. The video footage is footage of particular event types. In various examples, the event types include one or more of a basketball game, a baseball game, a soccer game, a football game, a hockey game, a martial arts competition, a swimming competition, a track and field competition, a gymnastics competition, a video game stream, a particular type of scripted event, or a combination thereof. The streamed event is of the same event type as the event type of the corpus video footage. In some examples, the AI module 308 trains the AI model on the corpus to understand the context of gameplay for certain event types, including positioning of players, the state of the game (e.g., game clock time, score, which team has possession), and sub-events (e.g., turnovers, scoring attempts). For example, the AI module 308 can train the AI model to recognize sub-events, which include specific in-game events. The sub-events serve as triggers for real-time actions (e.g., adjusting the overlay).

In some examples, the AI module 308 trains the AI model to continually track the game time, score, shot clock, and other game-specific conditions to drive automation. For example, the AI module 308 can train the AI model using historical game data, historical game video footage, annotated video data, and/or real-time sensor data associated with a sporting event. In some implementations, the AI model receives input data derived from video streams, scoreboard feeds, sensor data, or other data sources associated with the live event, and processes the input data to determine the current state of the game. For example, the determined game state can include an identification of a current period or quarter, the amount of time remaining in the game or in a possession, the current score differential, foul counts, timeouts remaining, possession indicators, or other conditions associated with gameplay.

The AI module 308 inputs the video content of the stream into the AI model. The identification module 312 identifies, in real-time, a sub-event based at least in part on an output of the AI model. In some examples, the AI module 308 trains the AI model to recognize sub-events based on the historical video footage. The update module 206 updates the parameter of the overlay based at least in part on the identified sub-event.

The computer vision module 310 inputs the video content into a computer vision model trained on a corpus of images of characters. In some examples, the characters are caricatures of well-known performers, such as athletes, musicians, artists, dancers, television personalities, or video game characters. In some examples, the computer vision model is trained to interpret visual elements in real-time during the streamed event. In some examples, the computer vision module 310 trains the computer vision model using one or more computer vision libraries, machine learning frameworks, or model development platforms, such as OpenCV®, Detectron2, TensorFlow®, PyTorch®, Keras®, Caffe®, Darknet®, a You Only Look Once (“YOLO”) based framework, or similar software tools configured to support the development, training, evaluation, and/or deployment of computer vision models. In some examples, the computer vision module 310 performs image preprocessing, dataset management, feature extraction, neural network training, object detection, image classification, image segmentation, and/or other computer vision operations.

In some examples, the computer vision module 310 is configured to recognize and track non-human objects within the video feed, such as a ball, a hockey puck, a stick, a racket, or any other objects used by the performers during the streamed events. The identification module 312 identifies, based at least in part on an output of the computer vision model and/or on an output of the AI model, a sub-event and a character corresponding to the sub-event. For example, the identification module 312 identifies the sub-event as a shot on goal and the character as a particular player. In some examples, the identification module 312 identifies characters in the video content by analyzing the video content via AI facial recognition and/or optical character recognition of text on the player's uniform.

In some examples, the overlay module 203 provides an additional overlay during the streaming. The additional overlay is based at least in part on the identified sub-event and the identified character and includes data relating to the sub-event and to the identified character, such as player statistics relating to an identified player. In some examples, the additional overlay includes real-time statistics.

The data display module 314 provides, via the UI and an API between the UI and an application, a display of data from the application corresponding to the video content. In some examples, the input module 204 receives, during the broadcast of the event and the UI, a user input. The data display module 314 updates, during the broadcast of the vent and based at least in part on the user input, the display of data provided by the API. In some examples, the API feeds live player statistics, scores, and/or events related to the game to the UI from the application. In some examples, the application includes at least one of a fantasy sports application, a betting application, and/or a sports data application.

In some examples, the data includes data provided by a party other than the party streaming and/or broadcasting the event. In other examples, the data includes data provided by the party streaming and/or broadcasting the event. In some examples, the data includes fantasy league data, recorded player statistics, social media content, news articles, betting odds, or a combination thereof. In some examples, the API interfaces with an application providing the data, such as at least one of: a social media platform, a social media application, a fantasy sports application, a news application, or a combination thereof. In some examples, the data display module 314 updates the displayed statistics in real-time. For example, the statistics include statistics regarding a player's points scored in the current season. In some examples, the identification module 312 identifies a sub-event as that particular player scoring a point, and the data display module 314 updates the displayed statistics in real-time in response to identifying that sub-event. The identification module 312, in some examples, updates the displayed statistics in real-time in response to receiving an update via the API and/or from the broadcasting party.

The authentication module 316 authenticates the user, via the API, into an account associated with the application with which the API interfaces via a UI. The data display module 314 provides the display of data corresponding to the video content in response to the authentication. For example, the authentication module 316 can transmit authentication requests through the API to a remote authentication service or account management system associated with the application. In some examples, the user provides authentication credentials through the UI, such as a username and password, a one-time verification code, biometric authentication, a token, or another form of authentication data. In some examples, the authentication module 316 transmits the authentication credentials through the API to verify the identity of the user and determine whether the user is authorized to access the application and associated content.

In some examples, the identification module 312 identifies a player profile corresponding to a particular object. For example, an object can include a player on the video stream. The user input includes a selection of that object, the identification module 312 identifies a player profile that corresponds to that object. For example, the object can be a video representation of a player by the name of John Smith. The identification module 312 identifies the object by analyzing the video and also identifies a player profile corresponding to John Smith. The data display module 314 then updates the display of data by including data corresponding to the identified player profile (e.g., of John Smith) in the display of data.

The NLP module 318 trains an NLP model on a corpus of commentary corresponding to a particular event type and tagged sub-events that correspond to portions of the commentary. In some examples, the corpus of audio includes recordings of spoken language associated with live events, broadcasts, commentary, interviews, or other spoken content. For example, the corpus can include audio data obtained from historical broadcasts, archived recordings, live event feeds, or other audio sources. In some examples, the audio data is accompanied by corresponding transcription data that maps segments of the audio to textual representations of the spoken words. The NLP module 318 uses the audio and corresponding transcription data to train the NLP model to recognize and interpret spoken language contained in the audio signals.

In some examples, the NLP module 318 trains the model to identify words, phrases, or contextual information contained within the audio corpus. For example, the NLP module 318 can train the NLP model to detect references to players, teams, events occurring during gameplay, or other contextually relevant information associated with a live event. In some examples, the trained NLP model can analyze incoming audio streams associated with a live event to generate outputs such as transcriptions, keyword detections, semantic labels, or other language-based outputs derived from the audio content.

The commentary module 320 provides a stream of commentary with the stream of video content. In some examples, the stream of commentary is a stream of audio provided by the entity broadcasting the video event. The commentary module 320 inputs the stream of commentary into the NLP model.

In some examples, the NLP module 318 uses the NLP model to convert the commentary to a text form and/or detect references to players, teams, events occurring during gameplay, or other contextually relevant information associated with a live event. In some examples, the identification module 312 identifies a sub-event based at least in part on text output of the NLP model. In some examples, the update module 206 updates, during streaming of the vent and based at least in part on the user preference and the sub-event identified by the commentary module 320, the parameter of the overlay on the stream of video content.

In some examples, the input module 204 receives a plurality of inputs from a user and/or from various users. The weighting module 322 assigns a different weighting value of a plurality of weighting values to each user input of the plurality of user inputs. The update module 206 updates the overlay based at least in part on the plurality of weighting values. In some examples, the plurality of user inputs are inputs of different types, and the weighting module 322 assigns weights based on input type. For example, the inputs can include one of the following received from a user device 102 through which the UI is provided: an audio input received from a microphone of the user device, input received through the UI, a user location, and a user's browsing history. In some examples, the weighting module 322 prioritizes direct inputs (e.g., audio received from the microphone or input received through the UI) over indirect inputs (e.g., user location determined based on location from the user's device and browsing history).

The feedback module 324 receives, in real time, feedback data indicative of a user satisfaction score. The update module 206 iteratively: (1) compares the user satisfaction score to a threshold user satisfaction score; and (2) further updates the parameter of the overlay based at least in part on a difference between the user satisfaction score and the threshold user satisfaction score. In some examples, the input module 204 receives input from the user relating to the user's satisfaction. Based on that input, the feedback module 324 determines a user satisfaction score. For example, the update module 206 can update an overlay to increase a size of a text of an overlay. The update module 206 determines a trend in user satisfaction based on user input regarding satisfaction received before and after the update to the overlay. The update module 206 compares the user satisfaction score to a threshold. In some examples, if the user satisfaction score is still below a threshold after the update, the update module 206 further updates the parameter.

In some examples, the UI module 326 provides the UI via a first user device 102 of a plurality of user devices 102. As such, multiple users can participate in a shared viewing session of the same live or recorded event. In some examples, the streaming module 202 provides a synchronized stream of the video content to the plurality of user devices 102. The overlay module 203 provides the overlay on the stream of video content to each user device 102.

In some examples, the overlay module 203 personalizes the overlay for each user. For example, the overlay module 203 can update an overlay for a first user based on that first user's preferences without updating the overlay for any of the other users. The overlay module 203 makes this update while maintaining a single live stream that is synchronized for all users of the synchronized stream, or watch party. As such, each participant's device 102 renders a personalized interface layer adapted to individual preferences, behaviors, or device capabilities. The custom UI apparatus 104 maintains temporal synchronization of live-event playback across participants while preserving localized adaptation logic, enabling each user to experience personalized overlays, data feeds, or visual themes in real time.

In some examples, shared session context data—such as collective reactions, chat activity, or event-triggered prompts—influence adaptive interface behavior across all connected participants, creating a synchronized yet individualized experience. For example, during a “watch-party” scenario, the custom UI apparatus 104 can synchronize key adaptive triggers (e.g., score changes, critical plays, or commercial events) across devices 102 while allowing each viewer to enable unique interface features such as fantasy tracking, merchandise offers, or social polls. In some examples, cross-device continuity extends to multi-screen households, allowing users to transition between devices (e.g., television, tablet, or headset) while retaining their active adaptive state, interface configuration, and synchronization within shared sessions.

The playback control module 328 controls the synchronized stream of the video content based at least in part on a playback control input received from the user. In some examples, the update module 206 selectively updates the parameter of the overlay on the stream of video content at a first user device 102 from among the plurality of user devices 102. In some examples, the first user device 102 is designated by the user as a host user device.

In some examples, the custom UI apparatus 104 generates and/or selects advertisements from a pool of advertisements based on received user inputs. In some examples, the AI model is trained to identify an advertisement for viewer engagement based on the user input received. The AI module 308 selects and displays an advertisement or other promotional material on the UI based on the output of the AI model.

In some examples, the AI module 308 outputs a suggested content change based on learned user behavior. For example, the AI model includes historical user data indicating that a particular user typically switches from a first broadcasted event to a second broadcast event featuring a favorite team of that user once the first broadcasted event begins. Based on the output of the AI model, the custom UI apparatus presents a notification providing an option for the user to switch to a different event stream, which is triggered by the start of another event featured offered through the OTT platform that features the favored team.

In some examples, the input module 204 supports both user-driven and AI-driven content selection relating to the display of data, overlays, and other interface elements. For example, the input module 204 can receive explicit user selections, such as selecting a player, choosing a viewing mode, expanding or minimizing certain overlays, or responding to system-generated prompts. In addition to such direct interaction, the input module 204 may further operate in an AI-driven content-selection mode in which the AI module 308 infers user preferences based on historical behavior, contextual factors of the streamed event, and real-time interaction patterns. In such examples, the update module 206 autonomously prioritizes or surfaces particular data sources, players, statistics, or graphic elements for the overlays without explicit user input. For instance, the custom UI apparatus 104 can automatically switch between different interface modes—such as a fantasy-focused view, a minimalist view, or an advanced statistics view—based at least in part on detected game context or learned user preferences. In another example, the AI module 308 determines that the user frequently navigates to alternate games or events featuring particular teams or performers and, in response, the apparatus presents or automatically surfaces recommendations for switching to such events, with or without prompting the user for confirmation.

Referring to FIGS. 2 and 4A, the overlay module 203 provides an overlay 412 over the streamed content on the UI 410. In various examples, the overlay 412 is a score bug that includes team identifiers 414, team scores 416, a period indicator 418, and/or a game clock 420. Although not shown in FIGS. 4A-D, in some examples, the overlay 412 also includes other game statistics, indicators of scores from other games, a shots tracker, a penalty tracker, news headlines, advertisements, branding logos, or a combination thereof.

In some examples, the input module 204 receives, via the UI 410, a user input. In one or more examples, the user input indicates a user preference relating to the display of the overlay 412. In some examples, the user input includes a selection and/or expansion of one or more of: the overlay 412, an element within the overlay 412 (e.g., the game clock 420), and/or a player 422. In some examples, the user input indicates a user preference. For example, as shown in FIG. 4A, the user may wish to expand the game clock 420 during the final minute of a period. In some examples, the custom UI apparatus 104 receives a selection of the game clock 420 from the user via the UI 410.

Referring to FIGS. 2 and 4B, in some examples, the update module 206 provides an update to the overlay 412 during streaming of an event and based at least in part on the user preference. For example, as shown in FIG. 4B, update module 206 is configured to enlarge the text of the game clock 420 in response to input from the user (e.g., the input illustrated in FIG. 3A). In some examples, the update module 206 is configured to enlarge the text of the game clock 420 without changing the dimensions of the overlay 412. In some examples, the update module 206 is configured to enlarge the text of certain elements of the overlay 412 (e.g., the game clock 420) with respect to the other textual elements of the overlay 412 (e.g., the period identifier 418).

In some examples, the update to the overlay 412 includes an enlargement of the overlay 412 element that triggers a change in the dimensions, position, and/or shape of the overlay 412. In some examples, the update is an enlargement of the text within the game clock 420, which also enlarges the entire game clock 420 such that it extends beyond the borders of the previous overlay 412.

Referring to FIGS. 2 and 4C-D, in some examples, the update module 206 learns user preferences and predict updates to the overlay 412 using an AI model. In some examples, the AI model is configured to link the user input to a sub-event. In some examples, the AI model is configured to link the user input to the sub-event by comparing time stamps of the occurrence of the sub-event and the received user input. For example, if the custom UI apparatus 104 receives input to enlarge the game clock 420 with 35 seconds remaining of the third period, the AI model can link the enlarged text preference to the last minute of a period. In some examples, the custom UI apparatus 104 receives input to enlarge the team scores 416 within 30 seconds of a goal being scored, and the AI model links enlarged team scores 416 to the sub-event of a goal.

Referring to FIGS. 2 and 4C-D, in some examples, the update module 206 triggers, during streaming of the event and/or streaming of a similar, subsequent event, an update to the overlay 412 based at least in part on an occurrence of a second sub-event and/or a similarity between the first sub-event and the second sub-event. In some examples, as shown in FIGS. 4A-B, the custom UI apparatus 104 receives, during streaming of a basketball game, an input from the user indicating a preference to enlarge the game clock 420. In this example, the remaining minute of the third period is the first sub-event. In some examples, the custom UI apparatus 104, during streaming of a subsequent basketball game, detects an occurrence of a second sub-event. The second sub-event is the remaining minute of the third period of that subsequent game. In some examples, the update module 206 is configured to compare the first sub-event (e.g., the remaining minute of the third quarter of the first basketball game) to the second sub-event (e.g., the remaining minute of the third quarter of the second basketball game) to determine a similarity between the two sub-events. In some examples, the update module 206 is configured to predict a user preference based at least in part on a similarity between the two sub-events.

In some examples, as shown in FIG. 4C, the update module 206 predicts that the user will want to enlarge the game clock 420 again based at least in part on the enlargement of the game clock 420 in the previous game, as shown in FIGS. 4A-B. In some examples, the update module 206 automatically updates the overlay 412. In other examples, the update module 206 suggests updates to the user and makes updates based at least in part on further user input.

In various examples, the update module 206 presents a notification 426 to the user via the UI 410. In some examples, the notification 426 asks the user if they would like to update the overlay 412 in a particular manner. As shown in FIG. 4C, the notification 426 provides the user with options to accept or deny enlarging the game clock 420. As shown in FIG. 4D, in response to the user confirming the change, the update module 206 enlarges the game clock 420.

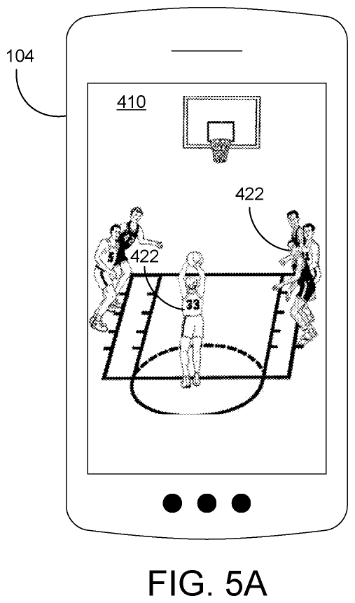

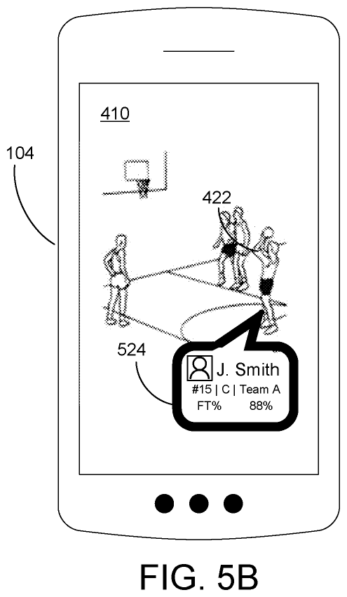

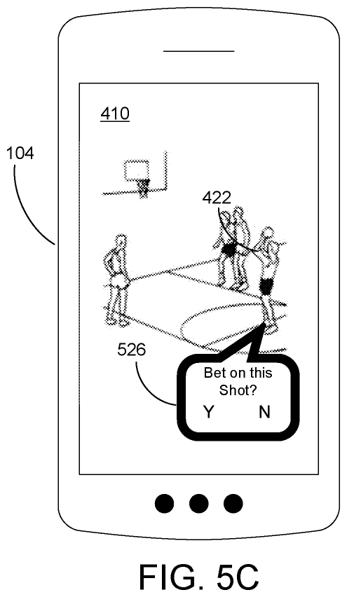

FIGS. 5A-C illustrate one example of a custom UI apparatus 104. In some examples, the streaming module 202 is configured to provide a stream of video content via a UI 410. In some examples, the stream of video content includes a broadcast of an event.

Referring to FIG. 5A, in some examples, the streamed event is a basketball game, and a sub-event is a free throw. In some examples, the custom UI apparatus 104 is configured to display data relating to the player taking the free throw shot through the API in response to determining that the sub-event corresponds to that player. In some examples, the custom UI apparatus 104 identifies one or more players 422 involved in a sub-event and automatically displays data relating to that player. Referring to FIG. 5B, in some examples, the custom UI apparatus 104 displays the data via an overlay 524. In some examples, the overlay 524 is in addition to or a replacement of the overlay 412 shown in FIGS. 4A-D. According to one or more examples, the overlay 524 includes data that corresponds to a recognized object 422, such as a player profile picture, a display name, a player number, a position, an affiliated team, and/or a statistic, such as a free throw percentage statistic. In some examples, the custom UI apparatus 104 provides the overlay 524 and data via an API with another application that provides data about the identified player.

Referring to FIGS. 2 and 5A, in some examples, a viewer starts watching an NBA game on their smart TV with default settings via the UI 410. In some examples, the update module 206 is configured to detect that the user frequently checks fantasy stats and betting odds via information handling devices 102 other than their TV, such as their remote and phone. In some examples, after a few games, the custom UI apparatus 104 suggests enabling “Fantasy Mode,” which expands player stat overlays 524 during particular sub-events, such as free throws and timeouts. In some examples, the custom UI apparatus 104 enables the fantasy mode in response to receiving user input indicating acceptance. In some examples, the user accepts but later manually reduces the size of betting odds. In some examples, the custom UI apparatus 104 stores the reduced size as a user preference and asks for confirmation before applying this adjustment to future games, ensuring user control. In various examples, over time, the custom UI apparatus 104 refines the UI 410 based on repeated interactions—e.g., by prioritizing player stats, adjusting transparency, and/or limiting certain overlays during sub-events.

In some examples, the update module 206 detects that the user manually expands a player stats overlay several times during particular sub-events, such as free throws and timeouts. In some examples, the UI includes a betting odds display toggle, and the update module 206 determines that a particular user frequently toggles the betting odds display toggle on and off but frequently shrinks a betting odds display overlay when the game is in motion. After detecting repeated interactions, the update module 206 determines, using the AI model, to suggest enabling Fantasy Mode, which expands player stats automatically during free throws and timeouts. In some examples, the update module 206 also preemptively minimizes betting odds when the shot clock is under 10 seconds, anticipating the user's past behavior.

In some examples, the update module 206 presents a notification seeking confirmation of a determined user preference (e.g., “Would you like to automatically show Fantasy Stats during free throws?”). The user can confirm one user preference while declining another (e.g., confirm a fantasy statistics overlay during the free throw sub-event while declining the minimize the betting odds based on the shot clock).

Referring to FIG. 5C, in some examples, the custom UI apparatus 104 presents a prompt overlay 526 on the UI 410 that prompts the user to make place a bet about the streamed event. In some examples, the custom UI apparatus 104 detects the sub-event (e.g., a shot) and prompts the user, through the prompt overlay 526, to make a bet about that sub-event. For example, the sub-event can be a free-throw shot, and the prompt overlay 526 can prompt the user to make a bet on the player making the shot. In some examples, the user's selection to make a bet activates the placement of a bet through a user's betting account. For example, the prompt overlay 526 can be provided using an API between a betting application and the streaming application.

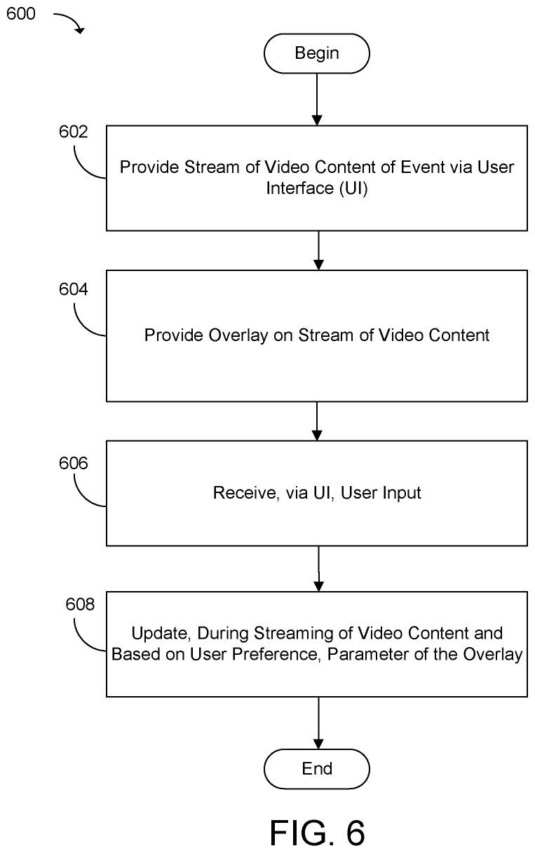

FIG. 6 is a schematic flowchart diagram illustrating an example of a method 600 for UI customization. In some examples, the method 600 begins and provides (block 602) a stream of video content via a UI 410. The method 600 includes providing (block 604) an overlay on the stream of video content. The method 600 includes receiving (block 606) via the UI 410, a user input. The user input includes a user preference. The user preference includes at least one of: a position of the overlay with respect to the video content, a font style of the overlay, a font size of the overlay, or a combination thereof. The method 600 includes updating (block 608), during streaming of the video content and based at least in part on the user preference, the parameter of the overlay 412 on the stream of video content, and the method 600 ends. In various examples, the streaming module 202, the overlay module 203, the input module 204, and/or the update module 206 perform the various steps of the method 600.

Examples may be practiced in other specific forms. The described examples are to be considered in all respects only as illustrative and not restrictive. The scope of the subject matter disclosed herein is, therefore, indicated by the appended claims rather than by the foregoing description. All changes which come within the meaning and range of equivalency of the claims are to be embraced within their scope.

As will be appreciated by one skilled in the art, aspects of the examples may be embodied as a system, method or program product. Accordingly, examples may take the form of an entirely hardware example, an entirely software example (including firmware, resident software, micro-code, etc.) or an example combining software and hardware aspects that may all generally be referred to herein as a “circuit,” “module” or “system.” Furthermore, examples may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain example, the storage devices only employ signals for accessing code.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

At least a portion of the modules include one or more of hardware circuits, programmable hardware circuits and executable code, the executable code stored on one or more computer readable storage media.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for examples may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one example,” “an example,” or similar language means that a particular feature, structure, or characteristic described in connection with the example is included in at least one example. Thus, appearances of the phrases “in one example,” “in an example,” and similar language throughout this specification may, but do not necessarily, all refer to the same example, but mean “one or more but not all examples” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

The term “about” or “substantially” or “approximately” in some embodiments, is defined to mean within +/−5% of a given value, however in additional embodiments any disclosure of “about” or “substantially” or “approximately” may be further narrowed and claimed to mean within +/−4% of a given value, within +/−3% of a given value, within +/−2% of a given value, within +/−1% of a given value, or the exact given value. Further, when at least two values of a variable are disclosed, such disclosure is specifically intended to include the range between the two values regardless of whether they are disclosed with respect to separate embodiments or examples, and specifically intended to include the range of at least the smaller of the two values and/or no more than the larger of the two values. Additionally, when at least three values of a variable are disclosed, such disclosure is specifically intended to include the range between any two of the values regardless of whether they are disclosed with respect to separate embodiments or examples, and specifically intended to include the range of at least the A value and/or no more than the B value, where A may be any of the disclosed values other than the largest disclosed value, and B may be any of the disclosed values other than the smallest disclosed value.

Furthermore, the described features, structures, or characteristics of the examples may be combined in any suitable manner. In the following description, numerous specific details are provided, such as examples of programming, software modules, user selections, network transactions, database queries, database structures, hardware modules, hardware circuits, hardware chips, etc., to provide a thorough understanding of examples. One skilled in the relevant art will recognize, however, that examples may be practiced without one or more of the specific details, or with other methods, components, materials, and so forth. In other instances, well-known structures, materials, or operations are not shown or described in detail to avoid obscuring aspects of an example.

Aspects of the examples are described below with reference to schematic flowchart diagrams and/or schematic block diagrams of methods, apparatuses, systems, and program products according to examples. It will be understood that each block of the schematic flowchart diagrams and/or schematic block diagrams, and combinations of blocks in the schematic flowchart diagrams and/or schematic block diagrams, can be implemented by code. These code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various examples. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding examples. Indeed, some arrows or other connectors may be used to indicate only the logical flow of the depicted example. For instance, an arrow may indicate a waiting or monitoring period of unspecified duration between enumerated steps of the depicted example. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate examples of like elements.

What is claimed is:

1. An apparatus, comprising:
a streaming module that provides a stream of video content of an event via a user interface (UI);
an overlay module that provides an overlay on the stream of video content;
an input module that receives, via the UI, a user input from a user, the user input comprising a user preference relating to a parameter of the overlay, the user preference comprising at least one of: a position of the overlay with respect to the video content, a font style of the overlay, a font size of the overlay, or a combination thereof; and
an update module that updates, during streaming of the video content and based at least in part on the user preference, the parameter of the overlay on the stream of video content,
wherein at least a portion of said modules comprise one or more of hardware circuits, programmable hardware circuits and executable code, the executable code stored on one or more computer readable storage media.

2. The apparatus of claim 1, further comprising an artificial intelligence (“AI”) module that trains an AI model on a corpus, the corpus comprising at least one of: the user input, a sub-event corresponding to the user input, an additional input from an additional user, an additional sub-event corresponding to the additional input, or a combination thereof.

3. The apparatus of claim 2, wherein the sub-event comprises an event occurring within the event within a given time of the user input.

4. The apparatus of claim 3, wherein the sub-event comprises a first sub-event and the update module triggers, during streaming of at least one of the streamed event and a subsequent streamed event, an update to the overlay based at least in part on an occurrence of a second sub-event.

5. The apparatus of claim 3, wherein:
the sub-event comprises a first sub-event;
the apparatus further comprises:
a computer vision module that inputs the video content into a computer vision model trained on a corpus of images of characters; and
an identification module that identifies, based at least in part on an output of the computer vision model and on an output of the AI model, a second sub-event and a character corresponding to the second sub-event; and
the overlay module provides, during streaming of at least one of the streamed event and a subsequent streamed event, an additional overlay based at least in part on the second sub-event and the identified character, wherein the additional overlay comprises data relating to the second sub-event and to the identified character.

6. The apparatus of claim 4, wherein:
the AI module inputs the second sub-event into the AI model, wherein the AI model is trained to identify a similarity between the first sub-event and the second sub-event; and
the update module:
determines an update to the overlay based at least in part on an output of the AI model; and
updates, during streaming of the at least one of the streamed event and the subsequent streamed event, the overlay based at least in part on the determined update.

7. The apparatus of claim 6, wherein the streamed event comprises a sporting event and the sub-event comprises at least one of: a goal, a game clock time, a shot clock time, a penalty, a foul, a shot on goal, a block, a replay, a hit, or a combination thereof.

8. The apparatus of claim 1, wherein:
the streamed event comprises an event of an event type; and
the apparatus further comprises:
an artificial intelligence (“AI”) module that:
trains an AI model on a corpus, the corpus comprising video footage of the event type; and
inputs the video content into the AI model;
an identification module that identifies, in real-time, a sub-event based at least in part on an output of the AI model; and
the update module updates the parameter of the overlay based at least in part on the identified sub-event.

9. The apparatus of claim 1, wherein:
the stream of video content comprises a broadcast of an event; and
the apparatus further comprises a data display module that provides, via the UI and an application programming interface (API) between the UI and an application, a display of data from the application corresponding to the video content;
the input module receives, during the broadcast of the event and via the UI, a user input; and
the data display module updates, during the broadcast of the event and based at least in part on the user input, the display of data provided by the API.

10. The apparatus of claim 9, wherein the broadcasted event comprises a sporting event and the displayed data comprises at least one of: recorded player statistics, fantasy league data, or a combination thereof.

11. The apparatus of claim 9, further comprising an authentication module that authenticates the user, via the API, into an account associated with the application, wherein the data display module provides the display of data corresponding to the video content in response to the authentication.

12. The apparatus of claim 9, wherein the user input comprises a selection of an object within the video content and the identification module identifies a player profile corresponding to the object.

13. The apparatus of claim 12, wherein the data display module updates the display of data by including data corresponding to the identified player profile in the display of data.

14. The apparatus of claim 1, wherein:
the apparatus further comprises:
a natural language processing (“NLP”) module that trains an NLP model on a corpus of commentary corresponding to an event type of the event and tagged sub-events corresponding to portions of the commentary;
a commentary module that provides a stream of commentary with the stream of video content and inputs the stream of commentary into the NLP model; and
an identification module that identifies a sub-event based at least in part on an output of the NLP model; and
the update module updates, during streaming of the event and based at least in part on the user preference and further based at least in part on the identified sub-event, the parameter of the overlay on the stream of video content.

15. The apparatus of claim 1, wherein:
the user input comprises a user input of a plurality of user inputs;
the apparatus further comprises a weighting module that assigns a different weighting value of a plurality of weighting values to each user input of the plurality of user inputs; and
the update module updates the overlay based at least in part on the plurality of weighting values.

16. The apparatus of claim 15, wherein the plurality of user inputs comprise at least one of the following received from a user device through which the UI is provided: an audio input received from a microphone of the user device, a user location, and the user's browsing history.

17. The apparatus of claim 1, wherein:
the apparatus further comprises a feedback module that receives, in real time, feedback data indicative of a user satisfaction score; and
the update module iteratively:
compares the user satisfaction score to a threshold user satisfaction score; and
further updates the parameter of the overlay based at least in part on a difference between the user satisfaction score and the threshold user satisfaction score.

18. The apparatus of claim 1, wherein:
the apparatus further comprises a UI module that provides the UI via a first user device of a plurality of user devices;
the streaming module provides a synchronized stream of the video content to the plurality of user devices;
the overlay module provides the overlay on the stream of video content to each user device of the plurality of user devices;
the apparatus further comprises a playback control module that controls the synchronized stream of the video content based at least in part on a playback control input received from the user; and
the update module selectively updates the parameter of the overlay on the stream of video content at the first user device from among the plurality of user devices.

19. A method, comprising:
providing a stream of video content of an event via a user interface (UI);
providing an overlay on the stream of video content;
receiving, via the UI, a user input from a user, the user input comprising a user preference relating to a parameter of the overlay, the user preference comprising at least one of: a position of the overlay with respect to the video content, a font style of the overlay, a font size of the overlay, or a combination thereof; and
updating, during streaming of the video content and based at least in part on the user preference, the parameter of the overlay on the stream of video content.

20. A program product comprising a non-transitory computer readable storage medium that stores code executable by a processor, the executable code comprising code to perform:
providing a stream of video content of an event via a user interface (UI);
providing an overlay on the stream of video content;
receiving, via the UI, a user input from a user, the user input comprising a user preference relating to a parameter of the overlay, the user preference comprising at least one of: a position of the overlay with respect to the video content, a font style of the overlay, a font size of the overlay, or a combination thereof; and
updating, during streaming of the video content and based at least in part on the user preference, the parameter of the overlay on the stream of video content.
